(19) United States
(12) Patent Application Publication
(10) Pub. No.: US 2021/0162351 A1
(43) Pub. Date: Jun. 3, 2021

(54) CONTINUOUS LATERAL PORE GRADING FOR SCALABLE EFFICIENCY OF MEMBRANES IN ELECTROCHEMICAL APPLICATIONS

(71) Applicant: Montana State University, Bozeman, MT (US)

(72) Inventors: Stephen W. Sofie, Manhattan, MT (US); Lee H. Spangler, Bozeman, MT (US)

(73) Assignee: Montana State University, Bozeman, MT (US)

(21) Appl. No.: 17/266,968

(22) PCT Filed: Sep. 9, 2019
(86) PCT No.: PCT/US2019/050255

§ 371 Date: Feb. 8, 2021

Related U.S. Application Data
(60) Provisional application No. 62/728,208, filed on Sep. 7, 2018.

(51) Int. Cl. B01D 67/00; H01M 8/0247; B01D 69/02; B01D 71/02; B01D 71/06

(52) U.S. Cl. CPC B01D 67/0013; H01M 8/0247; B01D 67/0004; B01D 67/0095; B01D 67/0046; H01M 2008/1095; B01D 69/02; B01D 71/025; B01D 71/022; B01D 71/06; B01D 67/0041

(57) ABSTRACT

Processes for manufacturing continuous laterally graded porous membranes are disclosed. Such processes utilize freeze casting techniques with a continuous varying solids loading method to make laterally graded porous membranes. Also disclosed are laterally graded porous membranes.

### FIELD

Disclosed are methods of making laterally graded porous membranes for catalyst and electrochemical devices, particularly methods of continuous grading of lateral porosity in tape cast membranes, and membranes made using the disclosed methods.

### SUMMARY

Disclosed are embodiments of processes for making laterally graded porous membranes and porous membranes made from those processes. In some embodiments the process for making a porous membrane, comprises manufacturing a laterally graded, porous membrane having a pre-selected porosity range and a preselected linear or non-linear gradient within the porous membrane by providing a first slurry, wherein the first slurry comprises a starting material in a solvent, wherein the solid starting material in the solvent has at least 1 vol % solids loading in the solvent, including one, several or all of a binder, a dispersant and/or a thickener; providing a second slurry, wherein the second slurry comprises a starting material in a solvent, wherein the solid starting material in the solvent has greater than 10 vol % solids loading in the solvent, including one several or all of a binder, a dispersant and/or a thickener; continuously mixing the first and second slurries together in controlled amounts to provide a casting material, wherein the casting material has controllable varying solids loadings; metering the casting material onto a casting bed to form a membrane cast; freeze tape casting the membrane cast; freeze drying the membrane cast to form the porous membrane having the pre-selected porosity range and the pre-selected gradient; and optionally sintering the porous membrane.

Any of the embodiments of the disclosed process may include continuously mixing the first and second slurries together in controlled amounts further comprises feeding slurry 1 at a defined rate, and feeding of slurry 2 as the feeding of slurry 1 is slowed. Any of the embodiments of the disclosed processes where not otherwise indicated, may include a solids loading of the first slurry in the range of 10 vol % to 40 vol % and the second slurry in the range of 10 vol % to 40 vol % or in the range of 20 vol % to 30 vol %. Any of the embodiments of the disclosed processes where not otherwise indicated, may include the resulting porous membrane having a thickness of from 100μu to 1 cm, or from 4 mm to 1 cm or from 100μu to 70 mm. Any of the embodiments of the disclosed processes where not otherwise indicated, may further comprise a third slurry, wherein the third slurry comprises a starting material in a solvent, wherein the solid starting material in the solvent has a pre-selected vol % solids loading in the solvent and wherein the third slurry is continuously mixed with the first slurry and/or the second slurry, in controlled amounts to provide the casting material. Any of the embodiments of the disclosed processes where not otherwise indicated, may include a fourth slurry, wherein the fourth slurry comprises a starting material in a solvent, wherein the solid starting material in the solvent has a pre-selected vol % solids loading in the solvent and wherein the fourth slurry is continuously mixed with the first slurry and/or the second slurry and/or the third slurry, in controlled amounts to provide the casting material.

Any of the embodiments of the disclosed processes where not otherwise indicated, may include a solvent in the first slurry and in the second slurry comprising water, or the solvent may consist essentially of water, or may consist of water.

Any of the embodiments of the disclosed processes where not otherwise indicated, may include a pre-selected porosity range of the porous membrane of from 40% to 99% and a preselected linear or non-linear gradient from 1% to 50%. Any of the embodiments of the disclosed process where not otherwise indicated, may include a pre-selected porosity range of the porous membrane from 50% to 90% and a preselected linear gradient from 2% to 40%.

Any of the embodiments of the disclosed processes where not otherwise indicated, may include a starting material comprising one or more polymers, one or more ceramic materials, one or more metals and/or metal compounds, one or more forms of carbon, or any mixtures thereof.

Some embodiments of the disclosed invention comprise a polymer starting material, or a polymer porous membrane, wherein the polymer comprises any suitable polymer, such as polyvinyl chloride, polyvinyl butyral, polyethylene, polypropylene, polystyrene, nylon, polyacrylonitrile, polyethylene terephthalate polytetrafluoroethylene, polyether ether ketone, an acrylic polymer, or any mixture thereof.

Some embodiments of the disclosed invention comprise a metal or metal compound starting material, or a metal or metal compound porous membrane, wherein the metal or metal compound comprises any suitable metal or metal compound, such as stainless steel, Fe, Sn, Zn, Ag, Ni, Cu, Al, Ti, Mg, Fe, Co, Mn, Pt, alloys of the metals, or any mixture thereof.

Some embodiments of the disclosed invention comprise a ceramic starting material, or a ceramic porous membrane, wherein the metal or metal compound comprises any suitable metal or metal compound, such as ceramic material comprises aluminum oxide, YSZ, zinc oxide, tin oxide, silicon nitride, SiC, zinc sulfide, cerium oxide, rhenium oxide, nickel oxide silicon oxide, perovskite, pyrochlore, garnet structure ceramics, Na/B modified glass, or any mixture thereof.

Any of the disclosed process embodiments may further include any suitable binder, such as polyvinyl alcohol, polyethylene glycol, polypropylene glycols, sucrose, sodium silicates, lignosulfonates, cellulose gums, Phoplex HA-12, or any mixture thereof.

Any of the disclosed process embodiments may further include any suitable thickener, such as methyl cellulose and/or xantham gum. Any of the disclosed process embodiments may further include any suitable dispersant.

Certain embodiments disclose a process for making a porous membrane, comprising producing a laterally graded, porous membrane having a pre-selected porosity range of from 50% to 95% and a preselected linear or non-linear gradient of from 51% to 94%, within the porous membrane by providing a first slurry, wherein the first slurry comprises a starting material in a solvent, wherein the solid starting material in the solvent has at least 10 vol % solids loading in the solvent; providing a second slurry, wherein the second slurry comprises a starting material in a solvent, wherein the solid starting material in the solvent has less than 40 vol % solids loading in the solvent; providing a slurry enhancement mixture separate from the first slurry and the second slurry, the slurry enhancement mixture comprising at least one binder and at least one thickener; mixing the first slurry, the second slurry and the slurry enhancement mixture together in controlled amounts to provide a casting material, wherein the casting material has continuously varying solids loadings; metering the casting material onto a casting bed to form a membrane cast; freeze casting the membrane cast; and freeze drying the membrane cast to form the porous membrane having the pre-selected porosity range and the pre-selected gradient.

Also disclosed are porous membranes formed by any of the processes disclosed herein. Any of the disclosed porous membranes may have a thickness of from 100μu to 1 cm, or a thickness of greater than 1 cm, and/or a laterally graded porosity throughout the thickness, in a single, integrated material that has not been laminated to achieve the laterally graded porosity.

Any of the disclosed laterally graded porous membranes may have a surface area of at least 5 M², or at least 1 M² or at least 10 cm². Any of the disclosed embodiments of the process may include utilizing a solvent, dispersant, binder and/or a thickener to cause impaction of ice crystal formation, growth and size. Any of the disclosed embodiments of the process may include varying freezing points by adding a depressant to slow freezing and affect ice crystal formation. Any of the disclosed embodiments of the process may include a freezing point depressant comprising propylene glycol and/or 1,3 propanediol. Any of the disclosed embodiments of the process may include a freezing point depressant comprising ethanol.

### BRIEF DESCRIPTION OF THE DRAWINGS

FIG. 1 are microphotographs of prior art membranes formed using traditional pore formers and pore forming technology.

FIG. 2 illustrates uneven distribution of pressure and concentration of inlet species from dilution and scaled membranes that can be ameliorated with engineering lateral porous membranes.

FIG. 3(a) and FIG. 3(b) illustrate (b) a schematic of the freeze tape casting process and (a) a micrograph of a freeze tape cast, low tortuosity ceramic material with the black regions representing pores with a length scale marker of 100 microns.

FIG. 4 is a schematic of the freeze tape casting process in which the microstructural development of ice crystals with regard to the freezing system is shown. The schematic also shows a top view of the ice crystals aligned in the Y axis direction of casting for which the embodiment of the disclosed invention provides the ability to grade pores laterally to change the pore size, volume, and morphology by manipulating delivery of the slurry.

FIG. 5(a) is a photograph of an embodiment of a freeze tape cast ceramic porous membrane at 15 vol % solids loading, as frozen prior to freeze drying; FIG. 5(b) is a photograph of an embodiment of a freeze tape cast ceramic porous membrane at 15 vol % solids loading after freeze drying and having been cut to desired sizes and shapes.

FIG. 6(a) is a graph showing embodiments with three different solids loadings and relative porosity, and microphotographs showing the resulting membranes wherein the dense particulate regions densify after a traditional sintering process, but large pores are retained. The shown microphotograph membranes are individually cast slurries of freeze tape cast yttria stabilized zirconium oxide (YSZ) at particular solids loadings. FIG. 6(b) shows the behavior of casts when the upper loading of solids is achieved and through the thickness ice-crystals is no longer observed.

FIG. 7 is a microphotograph of a freeze tape casted stainless steel materials at 25 vol % solids loading demonstrating the thicknesses that can be achieved and integrated with lateral grading methods.

FIGS. 8(a), 8(b) and 8(c) illustrate how embodiments of the disclosed lateral pore grading methods and resulting laterally pore graded membranes improve the distribution and delivery of reaction feedstock such as liquids or gases (here CO₂) to an active catalyst layer (as compared to traditional porous membranes) for improving the reaction efficiency (here formic acid conversion); FIG. 9(c) illustrates that the disclosed laterally pore graded membranes provide uniform delivery of feedstock to an active catalyst as the concentration of feedstock diminishes across scaled membranes.

FIG. 9 is a photograph showing different embodiment slurries prepared in a stepwise fashion showing the viability of continuously varying solids during the freeze tape casting processes disclosed herein. In certain embodiments such as shown in this figure, the slurries are run under a doctor blade assembly to merge the solids into a continuous tape, frozen, and freeze dried to generate laterally graded pore membranes.

FIG. 10 are photographs and microphotographs of embodiments of the disclosed laterally graded porous membranes.

FIG. 11 illustrates an embodiment of the disclosed processes for making laterally graded, porous membranes in slurries that are metered and mixed to continuously change solids content to fabricate tapes with lateral pore gradients.

FIG. 12 are graphs illustrating the tailorability of the disclosed laterally pore grading methods for making porous membranes.

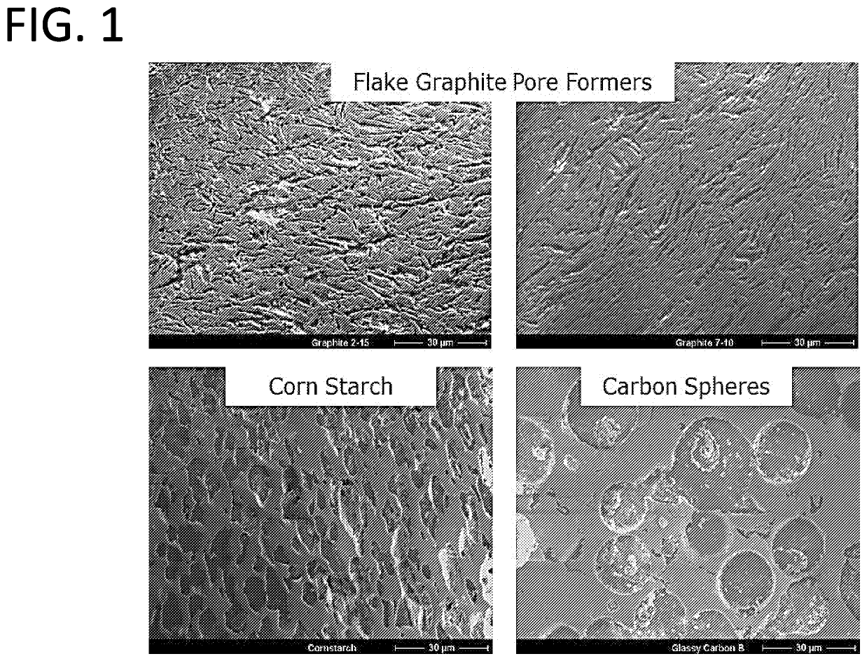

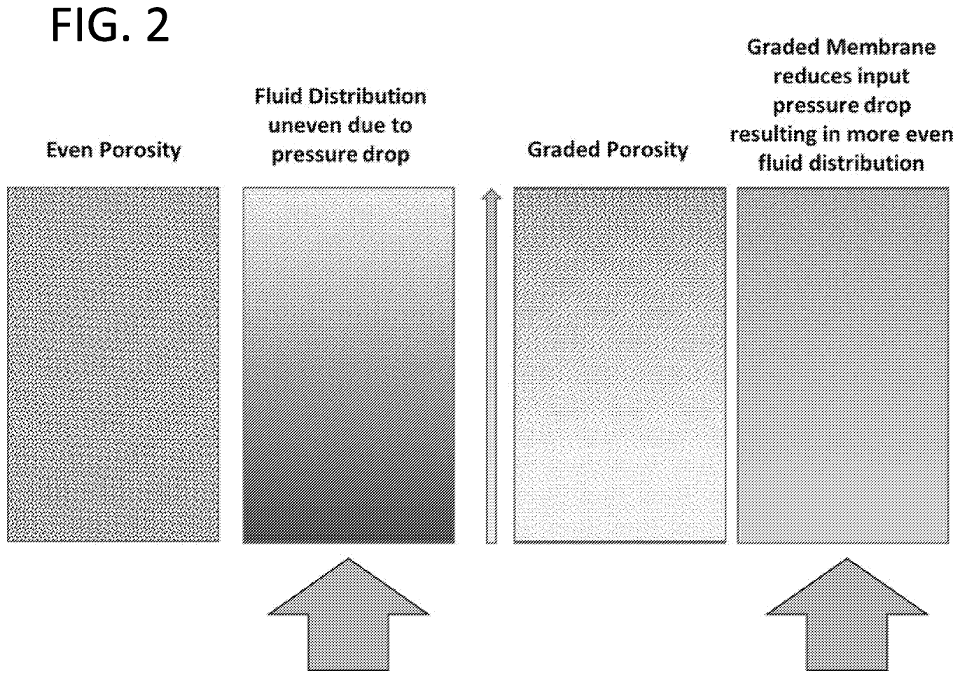

### DETAILED DESCRIPTION

Many electrochemical devices that require a planar structure for distribution of fluids that will be reacted in that structure use a porous membrane. Difficulties in industry have been encountered however with commercial scale implementation of processes using such porous membranes. Particularly, limitations in traditional porous membranes is a fundamental barrier to the scalable efficiency of layered device architecture in catalytic and/or electrochemical technologies, which is a critical gateway to commercial scale implementation. While methodologies exist to manipulate porosity and pore morphology in electrochemical support structures and integrated active materials, the results have been unsatisfactory. Accordingly, disclosed herein are methods and porous membranes made by the disclosed methods that address both axial and lateral pore gradients within diffusion layers.

When processes involving reactions utilizing porous membranes are commercially scaled-up, fluids flowing into one end of the structure are typically unevenly distributed due to the pressure drop at the inlet such that at the outlet there is less reactant available. As such, the overall efficiency of the reaction through the larger scale device is not equivalent to the same design and reaction done on a small scale device. For example, solid oxide fuel cells (SOFC) are subject to damage-inducing temperature gradients across stacked cells due to variations in electrochemical activity associated with fuel distribution and dilution. Polymer electrolyte fuel cell (PEM) research has focused efforts to establish water management solutions in the gas diffusion (GDL) and microporous layers (MPL), for which graded porosity is recognized as a key solution. In this manner electrochemical and catalytic device efficiency is often limited by the single pass utilization of fuel stocks, in which device output does not scale with area. The presently disclosed methods and membranes address these long-felt problems in electrochemical and catalytic industrial manufacturing. While known freeze tape casting processes have allowed for graded pores to be fabricated through the thickness (Z) directions with a contact width (X) direction over the entire length of the tape (Y) direction, the inventors herein provide processes that allow for gradients to be fabricated also in the Y direction.

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry and material science not defined below, may be found in Vladimir Novikov, Concise Dictionary of Materials Science Structure and Characterization of Polycrystalline Materials, published by CRC Press, 2003 (ISBN 0-8493-0970-0) and Richard J. Lewis, Sr. (ed.), Hawley's Condensed Chemical Dictionary, published by John Wiley & Sons, Inc., 2016 (ISBN 978-1-118-13515-0).

To facilitate review of the various embodiments of the disclosure, the following explanations of specific terms are provided:

Binder: as used herein a binder is polymeric casting additive used to hold the freeze tape cast particles (ceramic/metal/polymer/carbon) together after the tape is freeze dried. This facilitates cutting and shaping prior to use or thermal treatment.

Diffusion Layer: as used herein “diffusion layer” means a porous structure that allows gas to diffuse through it from one side of the structure to the other.

Dispersant: as used herein a dispersant is a polymeric additive used to adhered to the surface of the particles and foster stable dispersion (i.e. dispersions that resist agglomeration). Dispersions in aqueous based systems typically utilized electro-stearic mechanisms by which polymers adhering to the particle surface in addition to electro-static repulsion foster the dispersing mechanism.

Gradient Range: as used herein “gradient range” means the range from greater than 0 vol % up to the solids loading limit at freeze, continuous ice crystals no longer form, for example in some embodiments about 45-50 vol % solids (each class of materials has its own upper solids content limit defined by ice crystal formation as can be determined readily by those skilled in the art having tread this invention disclosure).

In Situ Porosity Varying: as used herein “in situ porosity varying” or “varying porosity in situ” means the solids loading, hence the water volume of the slurry is changed continuously during the casting process to influence the pore volume in 1-dimension or 2-dimensions (1-D or 2-D).

Modifying slurry concentration “in-situ” during development of pore formation, as used herein means causing a variation in the concentration of suspended solids in a fluid that is being metered out for freeze tape casting.

Laminated porous membranes: as used herein by “laminated membranes” it is meant that one formed porous membrane is attached to another porous membrane through use of warm pressing, solvent bonding, thermal treatment, adhesives, or heat treatments

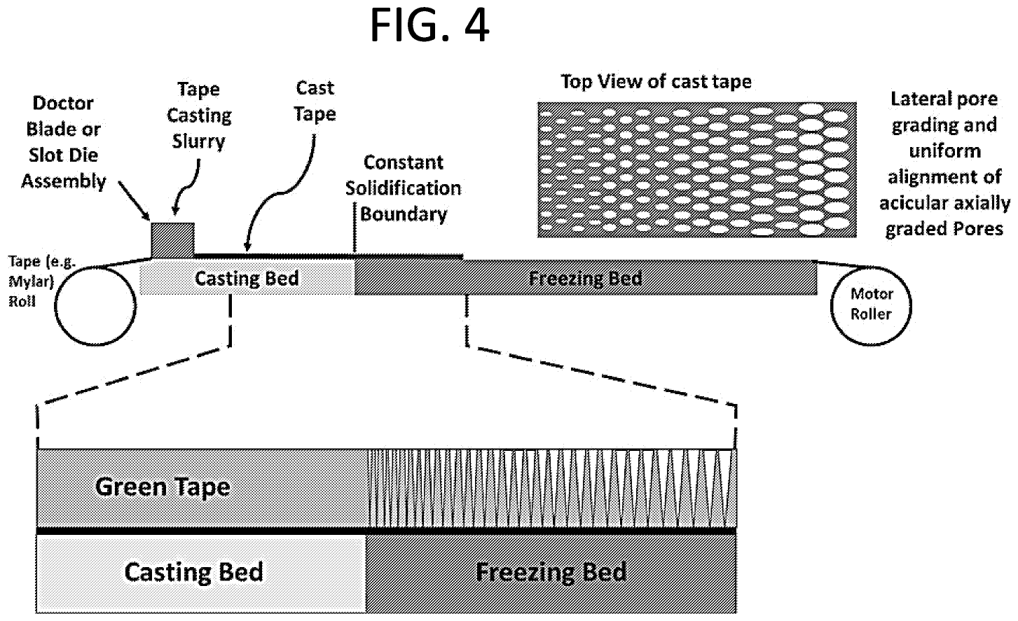

Laterally Graded Pores: as used herein “laterally graded pores” or “laterally grading pores” or “laterally graded pores” or “laterally graded porosity” mean that in a planar structure of in-plane dimensions X and Y with a thickness T, the porosity per unit area is varied in the X or Y or both dimensions. By way of further explanation, referring to FIG. 4, which is a microphotograph of an embodiment of the disclosed microstructure (membrane casting material) having a graded pore geometry, the oval shaped pores when viewed from the top can be aligned in a common direction in traditional tape casting. The membranes disclosed herein, however, made via the disclosed methods have laterally graded pores, that is the pore volume/size/distribution changes along the length of the cast tape (also referred to herein as lateral gradients).

As used herein a “laterally graded porous membrane” means a membrane with laterally graded pores as defined above.

Long Range Pore Alignment: as used herein “long range pore alignment” means that in one or more in-plane dimensions (X, Y or X and Y as defined above) acicular pore cross sections have their major and minor axes oriented in the same direction.

Pore Gradient: as used herein “pore gradient” means a variation in porosity along one dimension. “Lateral pore gradient” as used herein means a variation in porosity along one or both in-plane dimensions (X , Y or X and Y). As used herein “axial pore gradient” means a variation in porosity along the thickness dimension.

Pore Ordering: as used herein “pore ordering” means that elliptically shaped ice crystals are all oriented in common direction with respect to the cast tape, in which the long axis of the ice crystals corresponds to the long axis of the cast tape.

Pore Tortuosity: as used herein “pore tortuosity” means the actual pore path length divided by the thickness of the tape. Pores that extend through the thickness without discontinuity have a tortuosity of 1.

Porosity: as used herein “porosity” means the fraction of void volume to total volume in a material or structure. As used herein “controlled porosity” means the ability to control the ratio of void space to matter in a structure as well as the ability to change the fineness or roughness of the pores.

As used herein “porosity range” means the range of porosity that can be attained limited by the maximum solids loading where continuous ice crystals can grow.

Porous Membrane: as used herein “porous membrane” a structure containing pores that allows a fluid to pass from one side of the structure to the other.

Slurry: as used herein a “slurry” is a fluid containing a suspension of solid grains.

Solids Loading: as used herein “solids loading” means the amount of suspended solid grains per unit volume in a slurry.

Thickener: as used herein a “thickener” is polymeric additive uses to increase the viscosity of low solids loading slurries to provide a means to cast thin films that resist dewetting/dewatering and pooling on the Mylar (or other) carrier film.

Viscosity: as used herein “viscosity” means the internal resistance to flow exhibited by a fluid; the ratio of shearing stress to the rate of shear. Viscosity is determined by utilizing a Brookfield Digital Viscometer with a standard LV (low viscosity) spindle set. Measurements were made at room temperature to establish the needed thickener concentration to achieve the optimal casting quality.

In general, disclosed are processes for manufacturing a porous membrane, comprising manufacturing a laterally graded, porous membrane having a pre-selected porosity range and a preselected linear gradient within the porous membrane. The foundation of this manufacturing method is based on slurry processing, a solvent (water) and particulate powder. In certain embodiments, the membranes are manufactured by providing a first slurry, wherein the first slurry comprises a starting material in a solvent, wherein the solid starting material in the solvent has at least 5 vol % solids loading in the solvent, and providing a second slurry, wherein the second slurry comprises a starting material in a solvent, wherein the solid starting material in the solvent has greater than 5 vol % solids loading in the solvent. The first slurry and the second slurry are initially formed and kept separate from one another. In some embodiments, the slurries are formed together. The first and the second slurries are then mixed together in controlled amounts to provide a casting material, wherein the casting material has continuously varying solids loadings. The casting material is metered onto a casting bed or a substrate, or a substrate on a casting bed, to form a membrane cast. The membrane cast is then freeze casted and next may be freeze dried, to form the porous membrane having the pre-selected porosity range and the pre-selected gradient. In certain embodiments, the membrane cast is also sintered.

The starting material of the first and/or second slurries is the material from which the resulting membrane structure is formed. For example, if a metallic porous membrane is desired, a metallic starting material (pre-cursor) will be used. Embodiments wherein the starting materials is in the form of a powder are preferred and in some embodiments, a powder is required. The powdered starting material in certain embodiments are in the range of from 0.5 microns to 45 microns (325 mesh). The freeze tape cast process emphasizes the generation of substantial porosity also facilitating the use of nanno-particulate which disperses well at low solids loading. The upper limit of particle size is based upon particulate and solids that allow full exclusion of the particulate from growing ice crystals, as known to those of ordinary skill in the art having the advantage of reading this disclosure, with particle sizes that allow the freezing process to cause substantially complete (at least 99%) or complete particle exclusion (for example, grain sizes in the range of 0.1-50 microns, however, low density polymers can often cast at much larger particle sizes). The starting materials, and hence the resulting porous membranes may comprise one or more polymers, metals, metal compounds, ceramic materials (oxides, carbides, nitrides), or carbon (graphite, amorphous carbon).

In certain embodiments where a polymeric membrane is desired, the polymer starting materials may comprise any suitable polymer as known to those of ordinary skill in the art having the advantage of reading this disclosure. In some embodiments, the polymer starting material comprises polyvinyl chloride, polyvinyl butyral, polyethylene, polypropylene, polystyrene, nylon, polyacrylonitrile, polyethylene terephthalate polytetrafluoroethylene, polyether ether ketone, an acrylic polymer, or any mixture thereof, or custom polymer formulations that may be created to impart desired polymer properties. The polymer starting material is preferably, and in some embodiments must be, in the form of a powder prior to making the slurry, as would be as known to those of ordinary skill in the art having the advantage of reading this disclosure. In some embodiments, the polymer starting material is a solution. Commercial polymer formulations (in solvents or polymeric materials suspended in slurries) are readily available from many different sources and for some embodiments can be used as known to those of ordinary skill in the art having the advantage of reading this disclosure. In other embodiments, the polymer starting material may be in a non-powder form, that is, may take any suitable form, as known to those of ordinary skill in the art having the advantage of reading this disclosure.

In certain embodiments where a metallic membrane is desired, the starting materials may comprise any suitable metal or metal compound as known to those of ordinary skill in the art having the advantage of reading this disclosure. In some embodiments, the metallic starting material comprises stainless steel (such as 300 to 400 series), Fe, Sn, Zn, Ag, Ni, Cu, Al, Ti, Mg, Fe, Co, Mn, Pt, alloys of the metals, or any mixture thereof. In certain embodiments the metal starting material used may be in the form of a powder including alloys of other targeted metals reduced to a defined particle size distribution prior to making the slurry/suspension. Nanoparticles are viewed as a subset of finely powdered materials. In other embodiments, the metallic starting material may be in a non-powder form, that is, may take any suitable form, as known to those of ordinary skill in the art having the advantage of reading this disclosure.

In certain embodiments where a carbon membrane is desired, the carbon starting materials may comprise any suitable carbon as known to those of ordinary skill in the art having the advantage of reading this disclosure. In some embodiments, the carbon starting material is one or more of diamond particulates, graphite, graphene, activated carbon, amorphous carbon, carbon black, or acetylene black. The carbon starting material used may be in the form of a defined particle distribution in powder form or may be carbon in any form provided in a slurry or suspension. A slurry of carbon solids and/or liquid will be made into a carbon material containing casting slurry. In other embodiments, the carbon starting material may take any other suitable form, as known to those of ordinary skill in the art having the advantage of reading this disclosure.

In certain embodiments where a ceramic membrane is desired, the ceramic starting materials may comprise any suitable ceramic material as known to those of ordinary skill in the art having the advantage of reading this disclosure. In some embodiments, the ceramic starting material comprises aluminum oxide, YSZ, zinc oxide, tin oxide, silicon nitride, SiC, zinc sulfide, cerium oxide, rhenium oxide, nickel oxide silicon oxide, perovskite, pyrochlore, garnet structure ceramics, Na/B modified glass, or any mixture thereof. The ceramic starting material used may be in powder or liquid form in the event the ceramic material is suspended in a liquid, prior to making the feedstock slurry. In other embodiments, the ceramic starting material may take any other suitable form, as known to those of ordinary skill in the art having the advantage of reading this disclosure.

In certain embodiments, a solvent may be added to the starting material to make a slurry. The addition and mixing to form the slurry or one or more solid particle distributions, in certain embodiments, may include the steps of solvent/solid(s) agitation (low solids content), mixing in a mechanical (for example ribbon blender) in the event of high solids loading or using in line mixing for multiple streams as known to those of ordinary skill in the art having the advantage of reading this disclosure.

In certain embodiments, the solvent may comprise any suitable ceramic as known to those of ordinary skill in the art having the advantage of reading this disclosure, for example, the solvent may comprise water for water miscible materials. Water is an ideal solvent adding benefits of worker safety and being environmentally friendly. In certain embodiments, the solvent consists of water. In other embodiments the solvent consists essentially of water, meaning that other solvents added to do materially affect the amount of dissolution of the starting material. Certain embodiments of the disclosed processes target GRAS organic materials particularly as an added advantage to the manufacturing process of being environmentally friendly and safe for workers in the manufacturing environment. Examples of GRAS organic materials that can be employed as a solvent include, but are not limited or restricted to: acetone, benzyl alcohol, 1,3 butylene glycol, castor oil, citric acid esters, ethyl acetate, ethyl lactate, glycerin and glycerin derivatives, ethanol, hexane, i1,2 and 1,3 propylene glycol, isopropanol, monoglycerides and/or appropriate mixtures thereof. In certain embodiments, in addition to specific organic solvent properties with specific solids of interest there are secondary solvent considerations that provide additional tools for varying properties. For example, a need for easy removal of the solvent might use heating (ethanol, ethyl acetate, hexane can be easily removed by heating the cast materials). Solvent used to possibly control or modify freezing rates or temperature may comprise, for example, 1,2 or 1,3 propane diols (green antifreeze), glycerin and 1,3 butylene glycol, or any mixtures thereof.

In certain embodiments, the slurry may further comprise a binder. The binder is chosen to hold the particles of the starting material that forms the porous membrane together after the casting material is freeze cast and freeze dried so that the resulting porous membrane can be handled, manipulated and/or cut for its end use. The binder is chosen to adhere target polymers, oxides, metals, or other starting materials into a substantially uniform mixture to facilitate continuous tape casting. Examples of binders include but are not limited or restricted to polyvinyl alcohol, polyethylene glycol, polypropylene glycols, sucrose, sodium silicates, lignosulfonates, cellulose gums and commercial formulations like Phoplex HA-12. To illustrate binder selection options and utility if a metal or ceramic powder is used for Rhoplex HA-12 is a readily available latex emulsion binder utilized in the paint and pigment industry that is particularly useful in certain embodiments. This is non-water soluble acrylic latex particles suspended in water does not influence the freezing in a deleterious manner whereas other water soluble binders can in some degree act as an anti-freeze agent, which changes the way ice-crystals grow.

In certain embodiments, the slurry may further comprise a thickener. Thickeners are used for increasing the viscosity of solids materials (form and uniformity) to assure a flexible form after ice has been removed after casting. Further thickeners may be used to increase viscosity where needed. Thickeners may impact ice crystal growth. The thickener may comprise any suitable thickener as known to those of ordinary skill in the art having the advantage of reading this disclosure. In certain embodiments the thickener comprises methyl cellulose and/or xantham gum. Methyl cellulose and/or xantham gum are water soluble, can disrupt ice growth, and can drive substantial viscosity increase at less than 1 wt % of the water content. In certain embodiments, wherein the starting material is in a water slurry, from 0-1.5 wt % xantham gum may be used. The thickener is chosen to adjust the viscosity of the slurry. The viscosity of the slurries need to meet certain values such that the mixed slurries provide a casting material having a viscosity Slurry viscosity for tape casting is typically in the range of 1000-6000 m·Pa·s to maintain a uniform thickness after tape casting and prevent dewetting or dewatering of the base slurry. When a porous membrane is to be made, the viscosity of the slurry is preferably 1000-10,000 m·Pa·s regardless of the starting material being used.

In certain embodiments, the slurry may further comprise a dispersant. The dispersant binds to the surface of the particle to physically separate the particles in solution (thus allowing the water to wet the particulate) and/or the dispersant generates a static charge on the surface of the particle, so the particles repel. In some embodiments, the dispersant coats the particle with a short chain polymer and generates and electrostatic charge to facilitate mixture uniformity. Ammonium polymethacrylate is utilized in certain embodiments, and is particularly effective for ceramic oxide materials. It also works well with many metals since most metal powders have a thin oxide layer on their surface.

In certain embodiments, there may be two, three, four or more slurries provided to be mixed in controlled amounts to provide the desired casting materials. The goal in providing multiple slurries is to provide a means to shift in a real time continuous manor a prescribed mix of the two slurries each of whom has similar properties (type of solvent, thickener, dispersant, etc. except two separate solids loading contents. For example, in an embodiment having two slurries, one may include a 10% solids loading and a second a 30% solids loading. In certain embodiments utilizing two slurries, the process can be operated such that at time zero, slurry one is extruded continuously resulting in a length width of 10% solids content. At some time (length of the extruded cast material slurry 2 (30% solids) starts and slurry 1 stops, resulting in a 30% solids content for the remaining desired length. The resultant cast material (and resulting membrane) will thus have a first X length of 10% solids, an interim space of mixed 10% and 30% solids and the remaining length 30% solids. The cast materials after final processing, and sintering would have one end with a porosity of for example 90% while at the other end 60%.

In certain embodiments the solids loading of slurry 1 for example with 10% solids loading and slurry 2 with a 40% solids loading may be the starting materials and the freeze tape casting protocol operated such that slurry 1 and slurry 2 are inline mixed and sent to a casting line where starting solids content is 10% and the resulting solids content can be continuously shifted as a function of time and casting speed by lowering the feed rate of slurry 1 and progressively increasing slurry 2. The resulting cast material after sintering will exhibit increased porosity as a function of length starting with 10% and ending with 40% (porosity needs to be correlated with solids loading content).

In certain embodiments the type of material and solids loading of slurry 1 for example AL₂O₃ with 10% solids loading and slurry 2 with a 40% solids loading but made of ZrO may be the starting materials and the freeze tape casting protocol operated such that slurry 1 and slurry 2 are in-line mixed and sent to a casting line where starting Al₂O₃ solids content is 10% and the resulting solids content can be continuously shifted as a function of time and casting speed by lowering the feed rate of slurry 1 and progressively increasing slurry 2. The resulting cast material after sintering will exhibit increased porosity as a function of length starting with 10% and ending with 40% (porosity needs to be correlated with solids loading content) and the cast materials (the resulting membrane) composition will be comprise of 100% Al₂O₃ at the start and ZrO 100% at the end. Dissimilar materials may be incorporated into the cast materials.

In certain embodiments, more than two types of material and solids loading may occur for example slurry 1, slurry 2 and slurry 3 each of whom may have different materials and/or solids loading. Porosity can be continuously varied as a function of time and casting speed by lowering the feed rate of slurry 1 and progressively increasing slurry 2. The resulting cast material after sintering will exhibit increased porosity as a function of length starting with 10% and ending with 40% (porosity needs to be correlated with solids loading content) and the cast materials (the membranes) composition will be comprised of 100% Al₂O₃ at the start and ZrO 100% at the end. Dissimilar materials (several oxides as an example) may be incorporated into the cast materials.

### EXAMPLE 1

### Uniform Porosity

This example focuses on a single solids loading intended to be a balance of porosity for a given solid oxide fuel cell anodes (SOFC).

SOFC example: Tosoh TZ-8Y (cubic stabilized zirconium oxide)

Median powder 0.04 micron secondary cluster size 0.1-0.2 microns, with 16 M2/gm. SOFC anode membranes were cast at 20 vol % solids loading 14 inch wide 6 mm/minute freezing rate. Water, dispersant (1 wt % powder content) was ball milled in a 250 ml polyethylene milling jar for 12 hours utilizing ¼″ stabilized zirconia milling media. Many emulsion-based binders are shear sensitive and cannot be ball milled so the slurry was separated from the milling media using a coarse filter. The xantham gum thickener was added at 0.5 wt % of the powder content and homogenized using an ½″ ultrasonic horn. The acrylic emulsion binder is then added at 20 wt % of the powder content and mixed with a centrifugal rotary mixer to homogenize the slurry. The slurry is poured into a doctor blade reservoir with the blade gap set at 1 mm and the slurry was cast on a −30 C freezing bed at a rate of 6 mm/min so that a constant freezing front is observed as the slurry solidifies. The frozen tape is transferred to a shelf style freeze dryer and the water removed by sublimation overnight. The flexible tapes are then cut in the desired shape with a punch or other cutting instrument and sintered at 1400° C. for 2 hours to densify the strut regions for the preparation of solid oxide fuel cells. All associated casting organics are thermolyzed at less than 500° C. and the open freeze cast structure is conducive to fast ramp rates of >5 C/min. This example cast at 15 vol % solids which would yield about 85% porosity; for example, porosity is a uniform 15%.

### EXAMPLE 2

### Graded Stepped Porosity

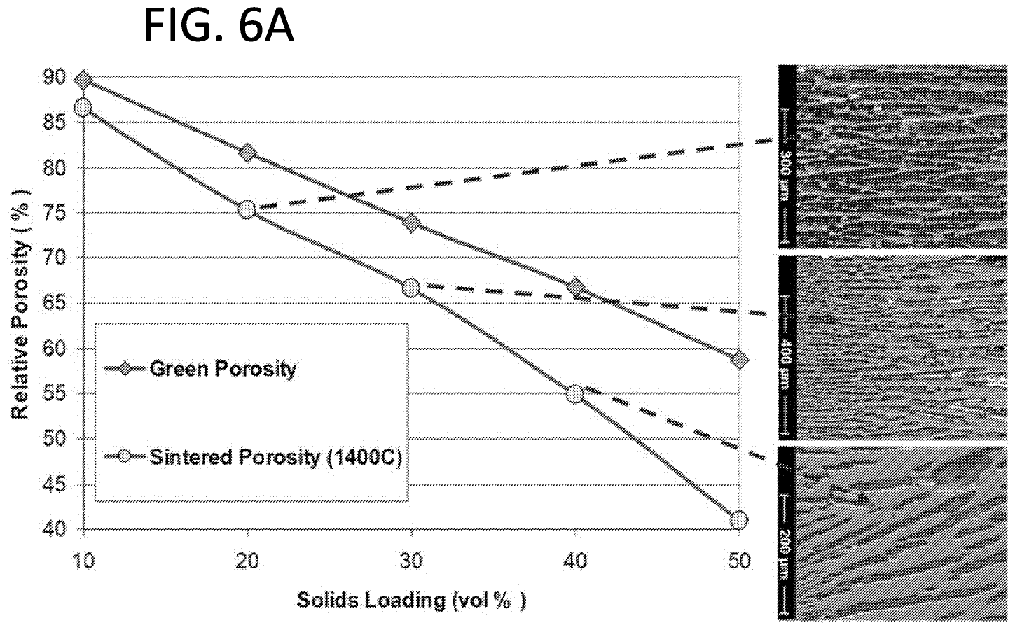

Graded Step Porosity. Al₂O₃ powder Almatis a 16-sg median 0.4 micron (0.3-0.65 range) 8.8 M2/Al₂O₃ Mix #1 was 20 vol % solids loading Al₂O₃ Mix #2 was a separate mix but with 30% loading. Water, dispersant (1 wt % powder content) was as used. A xantham gum thickener was added at 0.5 wt % of the powder content and homogenized using an ½″ ultrasonic horn. The acrylic emulsion binder was then added at 20 wt % of the powder content and mixed with a centrifugal rotary mixer to homogenize the slurry. The two slurries Mix 1 and Mix 2 were loaded into automatically controlled syringes where feed rates of each could be digitally calibrated and controlled separately. Mix 1 and Mix 2 was in-line mixed and poured into a doctor blade reservoir with the blade gap set at 1 mm and the slurry was cast on a −30° C. freezing bed (Mylar) at a rate of ˜6 mm/min so that a constant freezing front is observed as the slurry solidifies. The frozen tape was transferred to a shelf style freeze dryer and the water removed by sublimation overnight. The tapes were then cut in the desired shape. All associated casting organics were thermolyzed at less than 500° C. and the open freeze cast structure is conducive to fast ramp rates of >5 C/min. FIG. 6(a) establishes that a 20% solids loading (i.e. 80% water) yields a porosity of for example 75-82% while 30% solids result in 68-73% depending on the whether the tape is as cast or sintered. The porosity plot is surprising linear and should be largely independent of the solid material as it is based on the water content and the basis that all particulate is excluded during the freezing process. In summary: Solids loading: 5-45%; Binder: 5-30%; Dispersant: 0.5-1.5%; Thickener: 0.1-1.5%.

In this example, Mix 1 is fed continuously first and then tapered off while Mix 2 starts at zero and is ramped up resulting in an overall initial 20% solids loading followed by 30% solids with a gap space of mixed properties (solids loading between 20-30%) of, for example, of one inch (2.5 cm). Feed rates, freezing rates of Mix 1 and 2 are for example 4-20 cc/min NEED BETTER RATE. The resulting Al₂O₃ materials has a 20% loading going to 30% loading or a porosity of 75% going to 68% for example. Lower solids loading creates higher porosity while higher loadings create less porosity. The more water via freezing the higher the porosity. This demonstrates that at one end there is one density, loading and porosity while at the other end there can be another loading density and porosity.

### EXAMPLE 3

### Variable Graded Porosity

Variable Graded Porosity. A composition made according to EXAMPLE 2 is used. Al₂O₃ Mix #1 was 20 vol % solids loading assuming a powder density of 5.9 g/cm³. Al₂O₃ Mix #2 was a separate mix of 30% loading. Water and the particle dispersant (1 wt % powder content) is used to achieve a homogeneous slurry. A xantham gum thickener was added at 0.5 wt % of the powder content and homogenized using an ½″ ultrasonic horn. The acrylic emulsion binder was then added at 20 wt % of the powder content and mixed with a centrifugal rotary mixer to homogenize the slurry. The two slurries Mix 1 and Mix 2 were loaded into automatically controlled syringes where feed rates of each could be digitally calibrated and controlled separately. Mix 1 and Mix 2 were in-line mixed and poured into a doctor blade reservoir with the blade gap set at 1 mm and the slurry was cast on a −30° C. freezing bed (Mylar) at a rate of 6 mm/min so that a constant freezing front is observed as the slurry solidifies. The frozen tape is transferred to a shelf style freeze dryer and the water removed by sublimation overnight. The tapes are then cut in the desired shape. All associated casting organics are thermolyzed at less than 500° C. and the open freeze cast structure is conducive to fast ramp rates of >5 C/min. In summary: Solids loading: 5-45%; Binder: 5-30%; Dispersant: 0.5-1.5%; Thickener: 0.1-1.5%.

In this example, Mix 1 is fed continuously while Mix 2 starts at zero and is ramped up resulting in an overall initial 20% solids loading followed by a sequential linear increase in solids loading as a function of time. Feed rates, freezing rates of Mix 1 and 2 are for example 4-20 cc/min. The resulting Al₂O₃ materials has a 20% starting loading going to 30% final loading or a porosity of 75% going to 68% in increments of 1% for example. Lower solids loading creates higher porosity while higher loadings create less porosity. The more water via freezing the higher the porosity. This example illustrates the disclosed processes provide continuous variable solids loading hence continuous variable porosity as a function of length in the membrane resulting.

### EXAMPLE 4

### Graded Thickness Ice Porosity

Graded Thickness Ice Porosity. All basic materials used in EXAMPLE 3 will be used in EXAMPLE 4 except for a change in thickener.

Al₂O₃ powder as used in Example 3 Al₂O₃ Mix #1 was 20 vol % solids loading assuming a powder density of 5.9 g/cm3. Al₂O₃ Mix #2 was a separate mix of 30% loading. Water, dispersant (1 wt % powder content) was as used. In this example a propylene glycol thickener will replace xantham gum at 0.5 wt % of the powder content and homogenized using an ½″ ultrasonic horn. The acrylic emulsion binder was then added at 20 wt % of the powder content and mixed with a centrifugal rotary mixer to homogenize the slurry. The two slurries Mix 1 and Mix 2 were loaded into automatically controlled syringes where feed rates of each could be digitally calibrated separately. Mix 1 and Mix 2 were in-line mixed and poured into a doctor blade reservoir with the blade gap set at 1 mm and the slurry was cast on a −30° C. freezing bed (Mylar) at a rate of ˜6 mm/min so that a constant freezing front is observed as the slurry solidifies. The frozen tape was transferred to a shelf style freeze dryer and the water removed by sublimation overnight. The tapes are then cut in the desired shape. All associated casting organics are thermolyzed at less than 500° C. and the open freeze cast structure is conducive to fast ramp rates of >5 C/min. In summary: Solids loading: 5-45%; Binder: 5-30%; Dispersant: 0.5-1.5%; Thickener: 0.1-1.5% xantham gum replaced with in this case propylene glycol

In this example, Mix 1 is fed continuously (as in Example 3) while Mix 2 starts at zero and is ramped up (as in Example 3) resulting in an overall initial 20% solids loading followed by a sequential increase as a function of time of solids loading. Feed rates, freezing rates of Mix 1 and 2 are for example 4-20 cc/min. The resulting Al₂O₃ materials has a 20% loading going to 30% loading. However because of the freezing point depression of propylene glycol (freezing point −60 C) (ice is formed more slowly and hence ice crystals are smaller and of possible different conil surface area which translates into smaller average pore size. In short the choice of thickener (xantham gum) with a porosity of 75% going to 68% in increments of 1% for example can be compared with a propylene glycol substitute where porosity is 70% going down to 63%.

This example demonstrates the impact of one variable *thickener class/type) on the ability to manipulate and control porosity.

FIG. 6(a) establishes that 20% solids (i.e. 80% water) yields a porosity between 75 and 82% depending on the whether the tape is as cast or sintered. That plot is surprisingly linear and should be largely independent of the solid material as it is based on the water content and the basis that all particulate is excluded during the freezing process.

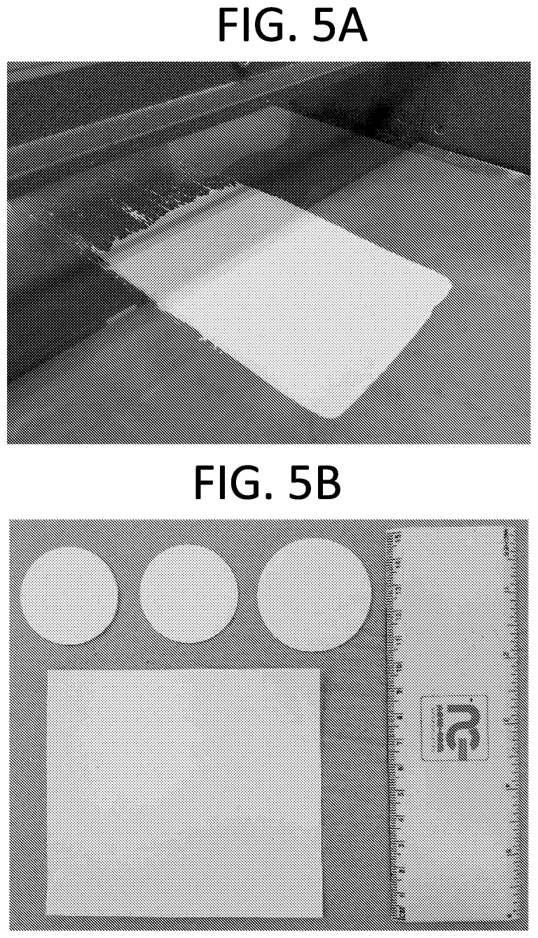

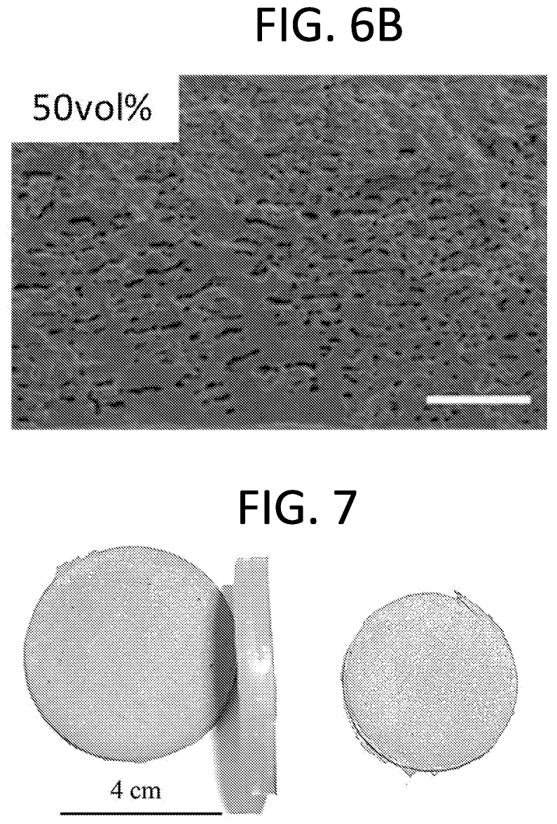

In certain embodiments, the solids loading in two or more slurries may be from 5-45%, the binders present in about 5-30 wt %, the dispersant at from 0.5-1.5 wt % and the thickener at from 0.1-1 wt %. In certain embodiments, the steps of mixing the slurries together in controlled amounts to provide a casting material is achieved through ultrasonic homogenization, ball milling, v-mixing, high shear mixing, and rotary centrifugal mixing. For ceramic materials ball milling is particularly effective, however for metals and polymers ball milling can deform the particles and change their shape. For such starting materials, ultrasonic mixing may be used in part as it does not damage the particles. As solids loading changes, thermal conductivity and hence freezing rate of the slurry can change, such that casting rates can be adjusted for each solids loading to achieve the long range order for high performance cast diffusion layers. Freeze tape casting with continuous solids loading varying can provide laterally pore graded membranes as thin as 100 microns and up to and beyond 1 centimeter (see FIGS. 5(b) and 7, providing the disclosed freeze tape cast, laterally pore graded membranes for device consolidation that far exceed the range obtainable through traditional tape casting.

In certain embodiments, the solids loading is digitally controlled using syringe pumps to meter the slurries into a static mixing nozzle to homogenize the slurry composition that can then be delivered to a doctor blade or slot die or even 3-D printing assembly to apply the slurry to the tape cast carrier. In certain embodiments, centrifugal slurry pumps, positive displacement or peristaltic pumps are used to meter multiple sets of slurries to vary the solids content. The variation of solids loading is the foundation for generating pore gradients. Given that solids loading is intimately related to the porosity through the water or other solvent content, variation of solids loading allows a simply method to tune the porosity through in-site adjustment that is made possible by the freeze tape casting process.

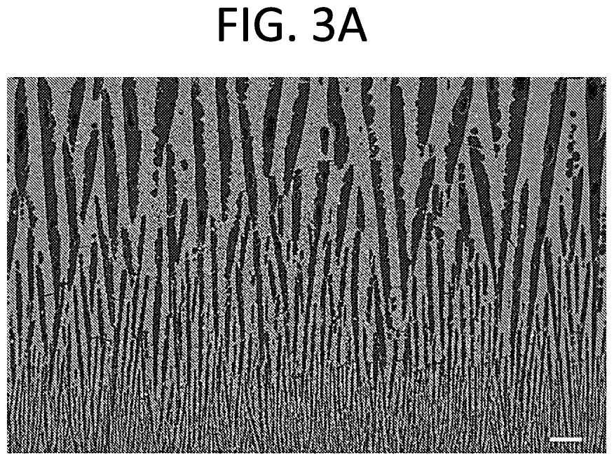

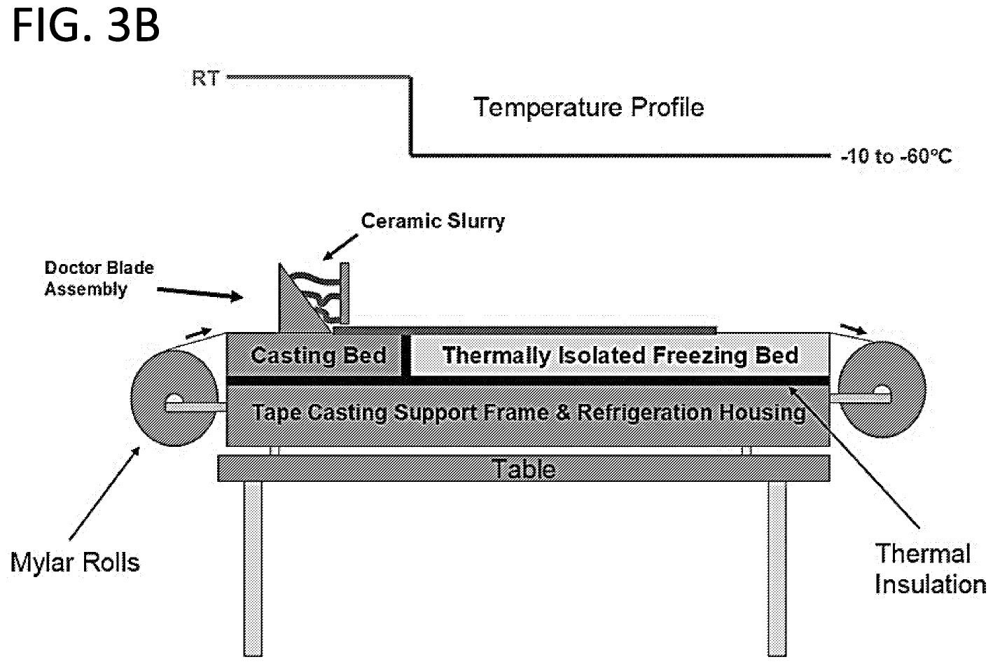

In certain embodiments, the casting material with continual varying of the solids loading is then metered out onto a casting bed, onto a substrate or onto a substrate on the casting bed, such as is shown in FIGS. 3(b), 4, and 5. At times in this disclosure and elsewhere, a casted material is referred to as “green tape” prior to the freeze casting step.

The substrate onto which the casting material is metered may comprise a polymeric carrier film, such as Mylar, cellophane, polymer films, metal foils such as aluminum foil, paper carriers or any suitable substrate as known to those of ordinary skill in the art having the advantage of reading this disclosure. Unless there was a specific necessity to directly incorporate the carrier and the freeze cast part (to make a bi-layer) there would be little reason to use an alternate polymeric carrier.

In certain embodiments, the casting material with continual varying of the solids loading is then metered out by use of a conventional doctor blade assembly, such as that shown in FIG. 3(b). As known by those skilled in the art, most any reservoir or slot die with the ability to set a gap thickness for the application of a thin film will work.

After the casting material is metered onto the substrate and/or casting bed to form the membrane cast, the membrane cast is freeze casted. To freeze cast the membrane cast, in certain embodiments a recirculating chiller that pumps a refrigerated solution to the underside of an aluminum plate to give precise temperature control (see, for example, FIG. 3(b)). Alternatively, a thermally isolated freezing bed can be used with a conventional refrigeration system, for example, based on Freon. Such devices scale readily to a commercial scale for manufacturing. As the membrane cast material reaches the freezing bed, FIGS. 3(b) and 4, ice crystals grow in the membrane cast material starting at the bottom of the membrane cast material layer. As the ice crystals grow they exclude particulate in the membrane cast material (see FIGS. 3(b) and 4) leaving ice crystals that essentially template the pores to be formed in the resulting porous membrane. The ice crystals are removed by sublimation to generate the porosity. As shown in FIG. 5(a) the freeze casted material comes out of the casting assembly. The pores or ice crystals do not show in this figure due to the white cover of the tape. The freeze cast material may then be freeze dried.

Following freeze casting, in certain embodiments the membrane cast is it then freeze dried or lyophilized. The membrane cast can be freeze dried by at a temperature and pressure that is below triple point of water (or whatever solvent is being used). This will allow sublimation to occur. If any part of the slurry were to melt, the resulting structure is likely to be unusable as a membrane. Driving the water from a solid to a gas and eliminating the liquid phase facilitated the preservation of the structure.

In certain embodiments the membrane cast or the porous membrane is then sintered. The sintering method depends upon the materials of which the porous membrane is formed and any other materials that may remain in the membrane cast material. Sintering can be performed by any means known by those of ordinary skill in the art that have had the benefit reading this disclosure or learning of this invention.

It is understood by those of ordinary skill in the art of freeze casting, that freeze tape cast pores are graded through the thickness and oriented along the lateral length of the cast tape under the ideal parameters. However, at any given spot in the tape the overall pore density is constant, meaning the same pore volume exists over the entire dimension of the tape. Laterally graded porosity as described here yields the unprecedented ability to change the porosity along the length of the tape, laterally.

In certain embodiments, the disclosed, laterally graded porosity membranes have a lateral pore gradient of from 95 to 45% porous in a single membrane that has not been laminated. Traditional membranes are only fabricated at fixed porosity and would thus require stitching together or laminating of multiple membranes to achieve a practical gradient. Lamination or stitching of membranes in the prior art not only adds in costs and time for making those membranes, but also produces membranes that can come unstitched or delaminated.

The disclosed laterally graded porous membranes could not have been achieved if using just a freeze casting system. The freeze tape casting process is the foundation to creating low tortuosity pores through the thickness of the membrane. The currently disclosed processes add an entirely new degree of freedom to freeze tape casting, that allows for a continuous gradient to be manufactured in the lateral dimension by a change in solids loading.

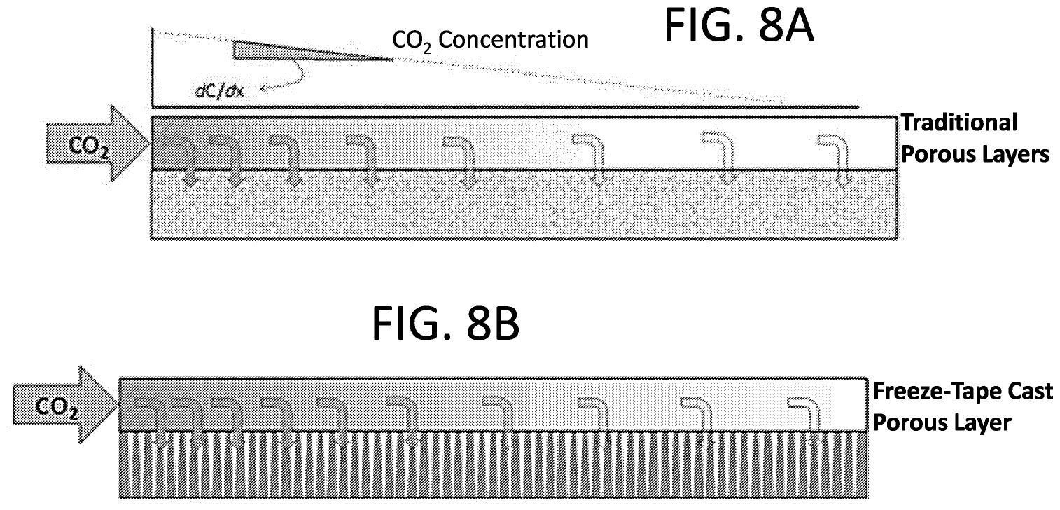

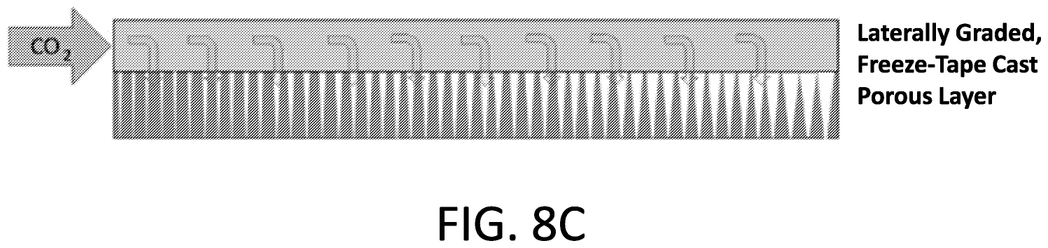

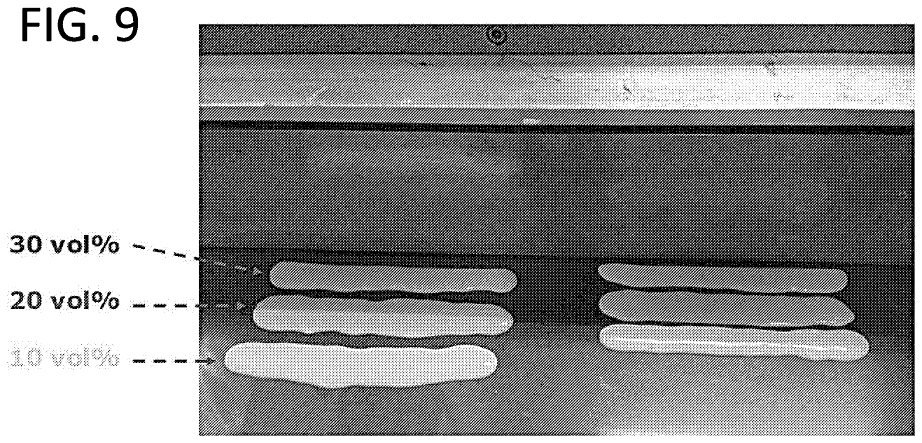

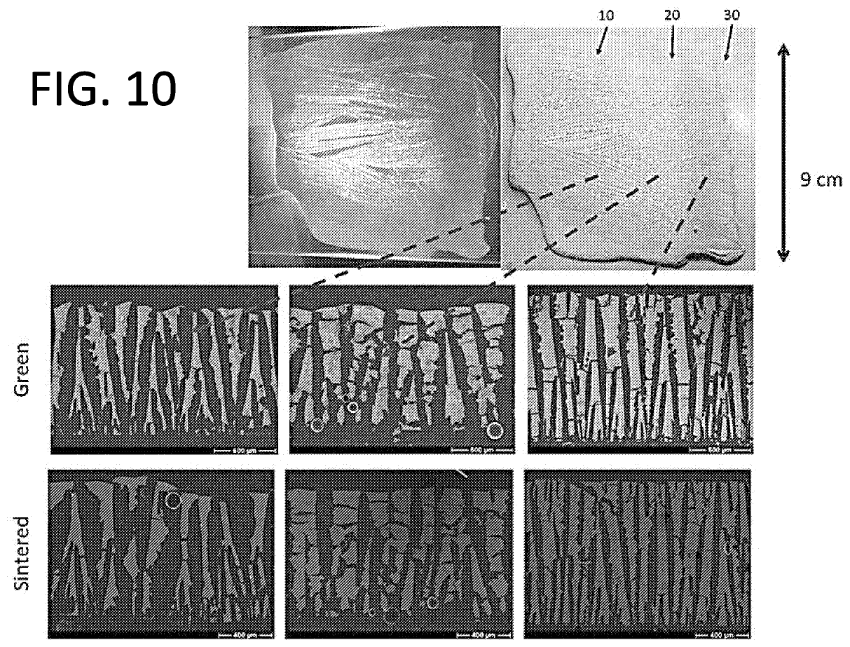

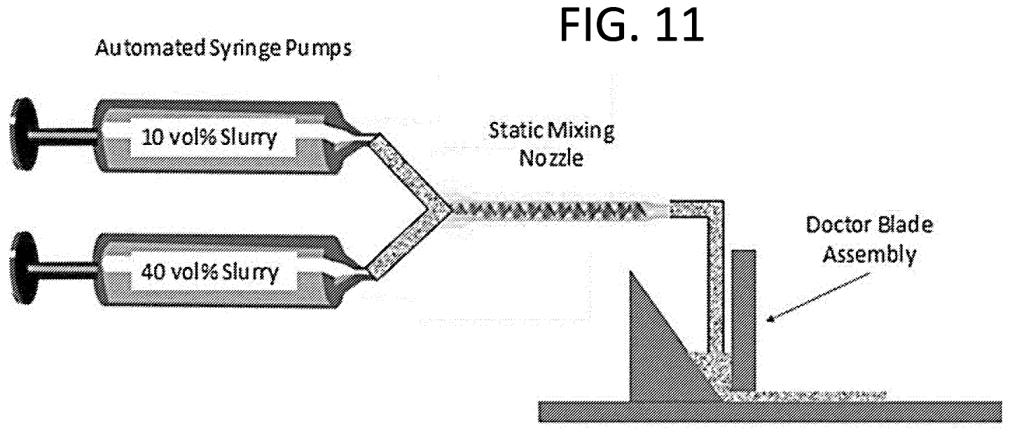

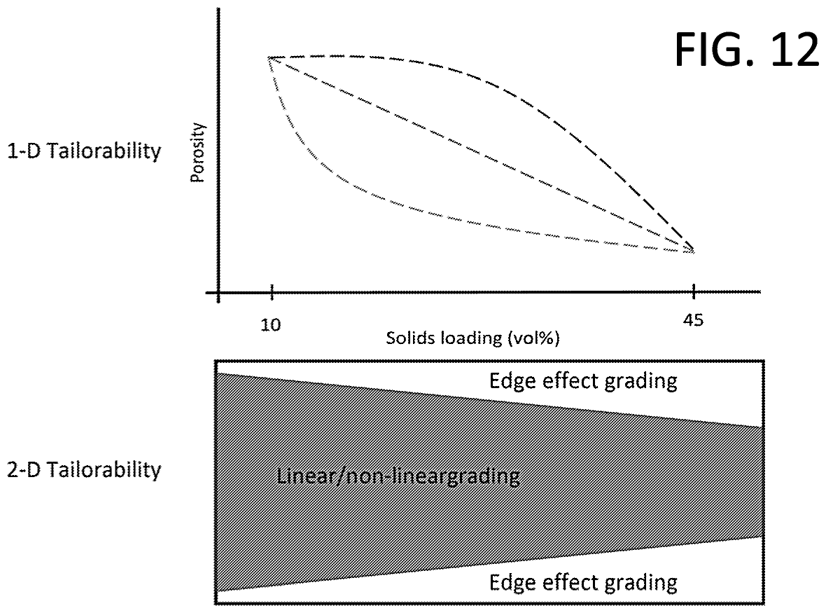

Likewise, the disclosed laterally graded porous membranes could not have been achieved using traditional tape casting methods with the inventors disclosed continuous solids loading processes. This is due to the fact that traditional tape casting yields highly tortuous pores, and varying solids loading in traditional tape casting will not give porosity variations, since the tape is dried during the process and excess solvent volume will collapse as the solvent in removed. In fact, the resulting laterally graded porosity membranes and the performance efficiencies of the same are more than the mere addition of freeze casting and continual varying of solids loadings, producing a synergy between the two resulting in the disclosed porous membranes. Such is evidence, for example, in viewing the efficiencies of a traditional porous membrane as compared to a laterally graded porous membrane. See for example FIGS. 8(a)-8(c) illustrating how embodiments of the disclosed lateral pore grading methods and resulting laterally pore graded membranes improve the distribution and delivery of reaction feedstock such as liquids or gases (here CO₂) to an active catalyst layer (as compared to traditional porous membranes) for improving the reaction efficiency (here formic acid conversion); FIG. 8(c) illustrates that the disclosed laterally pore graded membranes provide uniform delivery of feedstock to an active catalyst as the concentration of feedstock diminishes across scaled membranes.

As shown in FIG. 6(a), guidance is provided via data for lateral grading based upon the change in pore volume as shown. For example, at a substantially constant temperature, hence solidification rate, as the solids loading of particulate content of the slurry is decreased, the porosity is shown to increase in a nearly linear fashion. The increased porosity (overall pore volume) is realized through both an increase in pore size and pore density of the cast structure. As discovered and disclosed herein, there is through the disclosed methods the capability to freeze tape cast as low as 10 vol % solids loading, yielding a laterally pore graded membrane having approximately 90% porosity. The upper bound on solids loading is near 45 vol % solids loading, above which particle rejection during solidification is halted due to particle crowding. This provides guidelines for tailoring total porosity in freeze tape cast membranes from about 50-90% or an even broader range.

An important advantage of the disclosed freeze tape casting is the development of long range pore alignment that is conducive to fluid flow and maintaining low pore tortuosity over the length of the tape. FIG. 4 illustrates long range alignment is achieved through a constant solidification boundary in which the casting speed mirrors the solidification rate of the slurry. During casting at excess carrier speed, solidification can nucleate at multiple points in the tape, growing ice crystals that meet and disrupt long range order, alignment, and tortuosity as shown in FIG. 6(b).

In certain embodiments the laterally graded porous membrane is made of a polymer, a metal, a ceramic and/or carbon. Certain embodiments of the disclosed laterally graded porous membrane tapes can be made from 100 microns to 1 cm thick with porosities ranging from 45-95% and associated gradients that can range from 45-95%. Such embodiments possess these characteristics and properties in the absence of lamination, do so in a single integral membrane and do not include a supporting material or structure.

Embodiments of the disclosed laterally graded porous membranes have a surface area of at least 5 M², or at least 1 M² or at least 10 cm². For example, in the field of electrochemical conversion of carbon dioxide to formic acid for example at ambient conditions at 1.5 volts using nanno-tin as a catalyst on carbon fiber materials, surface area is currently restricted to 10 cm×10 cms due to non-uniform gas distribution. Commercially 1 M×1 M is required. The presently disclosed processes can form membranes much larger than 1 M². The current innovation can help in two ways. A graded porosity material made of oxides, for example, could be gradient designed to restrict CO₂ migration at the bottom of a vertical cell while increasing CO₂ at the top or vice versa. In short the invention could equalize the distribution of the reactant gas by controlling porosity as a function off height. Secondly structure could be used for membrane support.

The disclosed laterally pore graded membranes provide a revolutionary advance in all engineered porous materials including metals, ceramics, and polymers that enable the scaling of a broad range of electrochemical conversion technologies through manufacturing methodologies suitable for commercial scale implementation. The laterally graded pore structure also serves as a template for infiltrated catalysts resulting in a graded catalyst distribution which can provide additional control over spatial reaction distribution in electrochemical devices. This disclosed technology impacts at least the following applications but is not limited to these applications: heterogeneous catalysis; fuel reformation; electrochemical energy conversion (fuel cells and flow batteries); electrolysis; CO₂ conversion to formic acid and other products compositionally graded composites.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A process for making a porous membrane, comprising:
manufacturing a laterally graded, porous membrane having a pre-selected porosity range and a preselected linear or non-linear gradient within the porous membrane by
providing a first slurry, wherein the first slurry comprises a starting material in a solvent, wherein the solid starting material in the solvent has at least 1 vol % solids loading in the solvent, including one, several or all of a binder, a dispersant and/or a thickener;
providing a second slurry, wherein the second slurry comprises a starting material in a solvent, wherein the solid starting material in the solvent has greater than 10 vol % solids loading in the solvent, including one several or all of a binder, a dispersant and/or a thickener;
continuously mixing the first and second slurries together in controlled amounts to provide a casting material, wherein the casting material has controllable varying solids loadings;
metering the casting material onto a casting bed to form a membrane cast;
freeze tape casting the membrane cast;
freeze drying the membrane cast to form the porous membrane having the pre-selected porosity range and the pre-selected gradient; and
optionally sintering the porous membrane.

2. The process of claim 1 wherein the continuously mixing the first and second slurries together in controlled amounts further comprises feeding slurry 1 at a defined rate, and feeding of slurry 2 as the feeding of slurry 1 is slowed.

3. The process of claim 1, wherein the solids loading of the first slurry is in the range of 10 vol % to 40 vol % and the second slurry is in the range of 10 vol % to 40 vol % or in the range of 20 vol % to 30 vol %.

4. The process of claim 1, wherein the porous membrane has a thickness of from 100μ to 1 cm, or from 1 mm to 1 cm or from 100μ to 70 mm.

5. The process of claim 1, further comprising a third slurry, wherein the third slurry comprises a starting material in a solvent, wherein the solid starting material in the solvent has a pre-selected vol % solids loading in the solvent and wherein the third slurry is continuously mixed with the first slurry and/or the second slurry, in controlled amounts to provide the casting material.

6. The process of claim 6, further comprising a fourth slurry, wherein the fourth slurry comprises a starting material in a solvent, wherein the solid starting material in the solvent has a pre-selected vol % solids loading in the solvent and wherein the fourth slurry is continuously mixed Page 3 of 7 with the first slurry and/or the second slurry and/or the third slurry, in controlled amounts to provide the casting material.

7. The process of claim 1, wherein the solvent in the first slurry and the second slurry comprises water, or the solvent consists essentially of water, or wherein the solvent consists of water.

8. The process of claim 1, wherein the pre-selected porosity range of the porous membrane is from 40% to 99% and the preselected linear or non-linear gradient is from 1% to 50%.

9. The process of claim 1, wherein the pre-selected porosity range of the porous membrane is from 50% to 90% and the preselected linear gradient is from 2% to 40%,

10. The process of claim 1, wherein the starting material comprises one or more polymers, one or more ceramic materials, one or more metals and/or metal compounds, one or more forms of carbon, or any mixtures thereof.

11. The process of claim 10, wherein the polymer comprises polyvinyl chloride, polyvinyl butyral, polyethylene, polypropylene, polystyrene, nylon, polyacrylonitrile, polyethylene terephthalate polytetrafluoroethylene, polyether ether ketone, an acrylic polymer, or any mixture thereof.

12. The process of claim 10, wherein the metal and/or metal compound comprises stainless steel, Fe, Sn, Zn, Ag, Ni, Cu, Al, Ti, Mg, Fe, Co, Mn, Pt, alloys of the metals, or any mixture thereof.

13. The process of claim 10, wherein the ceramic material comprises aluminum oxide, YSZ, zinc oxide, tin oxide, silicon nitride, SiC, zinc sulfide, cerium oxide, rhenium oxide, nickel oxide silicon oxide, perovskite, pyrochlore, garnet structure ceramics, Na/B modified glass, or any mixture thereof.

14. The process of claim 1, wherein the binder comprises polyvinyl alcohol, polyethylene glycol, polypropylene glycols, sucrose, sodium silicates, lignosulfonates, cellulose gums, Phoplex HA-12, or any mixture thereof.

15. The process of claim 1, wherein the thickener comprises methyl cellulose and/or xantham gum.

16. The process of claim 1, wherein the first slurry and/or the second slurry further comprise a dispersant.

17. A process for making a porous membrane, comprising:
producing a laterally graded, porous membrane having a pre-selected porosity range of from 50% to 95% and a preselected linear or non-linear gradient of from 51% to 94%, within the porous membrane by
providing a first slurry, wherein the first slurry comprises a starting material in a solvent, wherein the solid starting material in the solvent has at least 10 vol % solids loading in the solvent;
providing a second slurry, wherein the second slurry comprises a starting material in a solvent, wherein the solid starting material in the solvent has less than 40 vol % solids loading in the solvent;
providing a slurry enhancement mixture separate from the first slurry and the second slurry, the slurry enhancement mixture comprising at least one binder and at least one thickener;
mixing the first slurry, the second slurry and the slurry enhancement mixture together in controlled amounts to provide a casting material, wherein the casting material has continuously varying solids loadings;
metering the casting material onto a casting bed to form a membrane cast;
freeze casting the membrane cast; and
freeze drying the membrane cast to form the porous membrane having the pre-selected porosity range and the pre-selected gradient.

18. A porous membrane formed by the process of claim 1.

19. A porous membrane having a thickness of from 100μ to 1 cm, or having a thickness of greater than 1 cm, and a laterally graded porosity throughout the thickness, in a single, integrated material that has not been laminated to achieve the laterally graded porosity.

20. The porous membrane of claim 18, wherein the porous membrane comprises a polymer porous membrane and the polymer comprises polyvinyl chloride, polyvinyl butyral, polyethylene, polypropylene, polystyrene, nylon, polyacrylonitrile, polyethylene terephthalate polytetrafluoroethylene, polyether ether ketone, an acrylic polymer, or any mixture thereof.

21. The porous membrane of claim 18, wherein the porous membrane comprises a metal porous membrane and the metal is stainless steel, Fe, Sn, Zn, Ag, Ni, Cu, Al, Ti, Mg, Fe, Co, Mn, Pt, alloys of the metals, or any mixture thereof.

22. The porous membrane of claim 18, wherein the porous membrane comprises a ceramic porous membrane and the ceramic comprises aluminum oxide, YSZ, zinc oxide, tin oxide, silicon nitride, SiC, zinc sulfide, cerium oxide, rhenium oxide, nickel oxide silicon oxide, perovskite, pyrochlore, garnet structure ceramics, Na/B modified glass, or any mixture thereof.

23. The porous membrane of claim 18, wherein it is a laterally graded porous membrane having a surface area of at least 5 M², or at least 1 M² or at least 10 cm².

24. The process of claim 1, further comprising utilizing a solvent, dispersant, binder and/or a thickener to cause impaction ice crystal formation, growth and size.

25. A process according to the process of claim 1, further comprising varying freezing point by adding a depressant to slow freezing and affect ice crystal formation.

26. A process according to claim 25, wherein the freezing point depressant is propylene glycol and/or 1,3 propanediol.

27. A process according to claim 25, wherein the freezing point depressant is ethanol.
